(19) United States
(12) Patent Application Publication
(10) Pub. No.: US 2011/0313887 A1
(43) Pub. Date: Dec. 22, 2011

(54) SYSTEM AND METHOD FOR IDENTIFYING DIGITAL MEDIA CONTENT AND DOWNLOADING THE CONTENT OR A PORTION THEREOF TO A MOBILE DEVICE

(75) Inventor: Leigh M. Rothschild, Sunny Isles Beach, FL (US)

(73) Assignee: LMR INVENTIONS, LLC, Sunny Isles Beach, FL (US)

(21) Appl. No.: 13/213,187

(22) Filed: Aug. 19, 2011

Related U.S. Application Data
(63) Continuation of application No. 11/479,366, filed on Jun. 30, 2006.

(51) Int. Cl. G06Q 30/00; G06F 17/30

(52) U.S. Cl. 705/26.62; 707/769; 707/E17.108

(57) ABSTRACT

A system and method are provided for identifying an article of commerce, e.g., digital media content, and downloading all or part of content related to the article of commerce to mobile devices such as portable digital media players and/or mobile phone devices. The present disclosure will enable a user to find an existing digital entertainment product of interest such as but not limited to a music CD, music DVD, electronic game, text (such as a book,) or a movie/television DVD, to identify that product and then to transfer full or selected content, or associated content, to a mobile device, e.g., a portable digital media player and/or a mobile phone device. The system and method of the present disclosure will provide on the spot delivery of the exact content identified by the user, or a portion thereof, on the user's portable digital device(s).

### PRIORITY

This application is a continuation application of U.S. Pat. No. 11/479,366, filed Jun. 30, 2006, the contents of which are hereby incorporated by reference.

### BACKGROUND

1. Field

The present disclosure relates generally to digital media content systems, and more particularly, to devices, systems and methods for identifying an article of commerce, e.g., digital media content, and downloading all or part of content related to the article of commerce to mobile devices such as portable digital media players and/or mobile phone devices.

2. Description of the Related Art

Portable digital devices are now common. Examples include the various Windows™ Pocket PC devices which have an operating system created by Microsoft Corporation of Redmond, Wash. Other devices include various mobile phone devices including many that have built-in camera imaging devices. Still other portable digital devices include portable media players from Creative Media of Singapore, Samsung of South Korea, Archos, Inc. of Irvine, Calif. and Apple Computers, Inc. of Cupertino, Calif.. Additionally, Sony of New York and Japan manufacture a portable game playing device called the Sony PSP™ (PlayStation Portable).

Increasingly, many of these portable media devices include a means of transmitting and receiving digital content. Various communications technologies are frequently built into these devices. Examples of portable communicating devices include mobile phones which employ GSM, CDMA, W-CDMA, and FOMA technology, among other standards, to send and receive data in addition to handling voice communications. Many of the portable media devices also include transmission capabilities including WiFi (IEEE 802.11a, b, g and x among others), Bluetooth, infrared, etc. to allow the user to transmit and receive digital content. The Sony PSP™ device, by example, includes WiFi (i.e., IEEE 802.11b) to transmit and receive digital data.

In this age of ‘instant gratification and information’, a need exists for a system and method to allow a consumer to identify digital content at a location for this content (such as a retail store) and to immediately download this content into the user's mobile device, e.g., a portable media player device or mobile phone.

### SUMMARY

A system and method are provided for identifying an article of commerce, e.g., digital media content, and downloading all or part of content related to the article of commerce to mobile devices such as portable digital media players and/or mobile phone devices. The present disclosure will enable a user to find an existing digital entertainment product of interest such as but not limited to a music CD, music DVD, electronic game, text (such as a book,) or a movie/television DVD, to identify that product and then to transfer full or selected content, or associated content, to a mobile device, e.g., a portable digital media player and/or a mobile phone device. The system and method of the present disclosure will provide on the spot delivery of the exact content identified by the user, or a portion thereof, on the user's portable digital device(s).

### BRIEF DESCRIPTION OF THE DRAWINGS

The above and other aspects, features, and advantages of the present disclosure will become more apparent in light of the following detailed description when taken in conjunction with the accompanying drawings in which:

FIG. 1A is front view of a device for playing media content according to an embodiment of the present disclosure;

FIG. 1B is a rear view of a device for playing media content;

FIG. 2 is a block diagram of various modules included in the device illustrated in FIG. 1;

FIG. 3 illustrates a system for delivering media content to a user; and

FIG. 4 is a flow diagram illustrating a method for delivering media content to a user according to an embodiment of the present disclosure.

### DETAILED DESCRIPTION

Preferred embodiments of the present disclosure will be described hereinbelow with reference to the accompanying drawings. In the following description, well-known functions or constructions are not described in detail to avoid obscuring the present disclosure in unnecessary detail.

A device, system and method for delivering media content to a user are provided. The system and method allow a user to identify digital content at a location for this content (such as a retail store) and to immediately download this content into the user's portable media device or cellular/mobile phone. This will provide the user with not only instant delivery, but a seamless way of obtaining the content (as opposed to manually loading the content), and in many cases a better economic model to obtain the content. The system and method will enable the user to compare the price of the content at the source (e.g., a retail store) and to instantly receive the content from an Internet source or sources. Further, the user may custom select the content that he desires and, instead of obtaining all content, the user may decide to purchase less of the content (e.g., a content subset) therefore customizing his selection, and reducing his/her price for the content.

In operation of the system and method of the present disclosure, a user locates an article of commerce such as a book, video or audio DVD, audio CD, electronic game, etc. The user utilizes a portable digital device, e.g., a mobile phone, to identify the article of commerce. Several technology solutions are provided to allow the article to be identified by a user, e.g., a device containing a CCD device (e.g., a camera) where the user will take a picture of a barcode on the article of commerce; a device containing a user interface allowing user keyboard input where the user will input the name of the item into the portable device; the user may speak the name of the article of commerce into the portable device where the device contains voice recognition software, etc. In a further embodiment, the articles of commerce will contain Radio Frequency Identification (RFID) tags wherein these tags identify the article of commerce to a reader device. Furthermore, if the device contains a CCD device (e.g., a camera), the user can also take a picture of the article of commerce and using standard and existing computer processing power and software solutions such as image recognition software, or optical character recognition software, the image or name of the article of commerce is decoded and the identity of the article of commerce is resolved.

Once the article of commerce is identified, the portable device will use communications protocols including but not limited to WiFi (a, b, c d, n, x), cellular communications such as GSM, CDMA, FOMA, etc., infrared communications, cabled communications, Bluetooth communications, satellite communications, etc., to transmit this identification information to a remote server on the global computer network (GCN), e.g., the Internet. The user will also transmit information identifying the user submitting the request. The server will then use standard computer processing power and standard data look up software to see if it has information, e.g., content, on the article of commerce. The server will use standard communications protocols to transmit information back to the portable digital device. The user will now be informed (by the server) what content or parts of content for the selected article of commerce is available for download. The user will also be informed of the price of this download, and the user will be informed where the download will be sent to.

If the user wants to purchase this download, the user will now use the user interface that is built into his portable digital device including but not limited to character input, voice input, etc. to select the desired content. This information will then be transmitted to the server. The server will use standard computer processing power and e-commerce software to commence a transaction. Once (and if) the transaction is approved, the server will transmit the digital content to the address that the user has provided, e.g., the device used to conduct the transaction or another digital device such as a user's local computer. Alternatively, the user will select the desired content to preview the content at no cost to the user. The preview view of the content may be a portion of the selected content or the complete selection. If a portion is transmitted to the device, the user may purchase the complete selection after previewing the portion. Furthermore, the complete selection may be transferred to the user where only a portion is available for preview and the remainder of the selection is available after purchase, e.g., by the server providing a key after purchase. In another embodiment of this disclosure, the server may not have stored the digital content, but it may cause another site on the global computer network where the subject digital content is stored, to transmit the content to the user at the address provided.

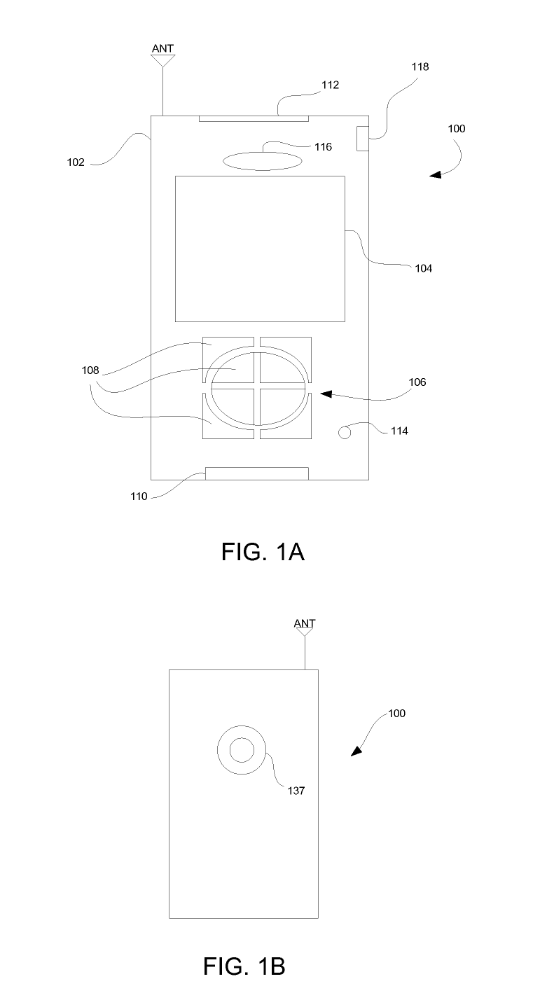

Referring to FIG. 1A, a portable media playback device 100 for receiving and playing various types of digital media content, e.g., audio, video, images, games, text, multimedia content, etc., in accordance with an embodiment of the present disclosure is illustrated. The media device 100 includes various electrical components, which will be described in detail below, disposed in a generally rectangular housing 102. A display module 104 is provided for displaying video and image media content, such as movies, animations, etc. and a speaker 116 is provided configured to produce audio, e.g., music or a soundtrack associated with a video. An audio port 118 will be configured to receive a plug or connector from a headphone, stereo system, etc. to stream the audio to the connected device. It is to be appreciated that when an external device is connected to the audio port 118 the speaker 116 will be disabled. Input module 106 includes a plurality of buttons 108 for inputting data and navigating through a plurality of menus. A touch screen overlaid upon the display module 104 may also be coupled to the input module for facilitating user input. The media device 100 further includes a storage module 110 for storing a plurality of content and a transmission module 112 for transmitting/receiving data and/or content to another device, e.g., a personal computer, a personal digital assistant (PDA), a server residing on the Internet, etc. Optionally, the media device 100 may include a microphone 114 for acquiring audio from the user of the device to input data.

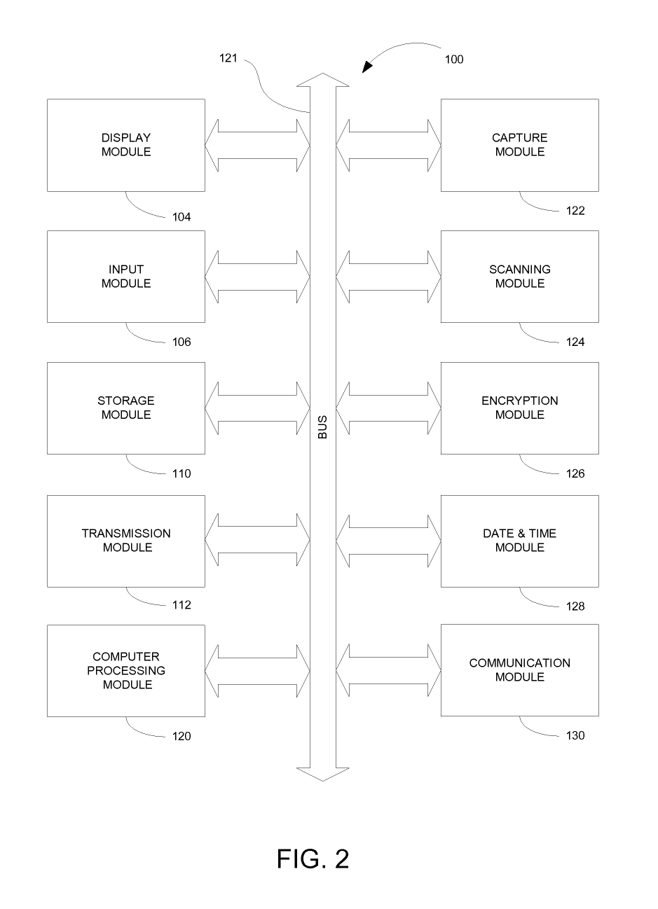

Referring to FIG. 2, the various components of the device 100 will now be described. The device will contain a computer processing module 120, e.g., a microprocessor. The computer processing module 120 will use computer software instructions that have been programmed into the module and conventional computer processing power to interact and organize the traffic flow between the various other modules. It is to be understood that the present disclosure may be implemented in various forms of hardware, software, firmware, special purpose processors, or a combination thereof. A system bus 121 couples the various components shown in FIG. 2 and may be any of several types of bus structures including a memory bus or memory controller, a peripheral bus, and a local bus using any of a variety of bus architectures. The device also includes an operating system and micro instruction code preferably residing in read only memory (ROM) (not shown). The various processes and functions described herein may either be part of the micro instruction code or part of an application program (or a combination thereof) which is executed via the operating system. Exemplary operating systems include but are limited to SymbianOS, Windows Mobile/Windows CE, Palm OS, Linux, Blackberry OS, BREW, etc. which have been developed for mobile computing applications and can handle both data computing and communication applications, e.g., voice communications.

It is to be further understood that because some of the constituent device components and method steps depicted in the accompanying figures may be implemented in software, the actual connections between the device components (or the process steps) may differ depending upon the manner in which the present disclosure is programmed. Given the teachings of the present disclosure provided herein, one of ordinary skill in the related art will be able to contemplate these and similar implementations or configurations of the present disclosure.

The computer processing module 120 may further include, in addition to a microprocessor, a digital signal processor (DSP) for decoding stored audio, video and photo files to be played on the media device 100. As is known in the art, the DSP may include several known decompression algorithms for decompressing stored media content, e.g., a MP3 file. The device 100 of the present disclosure will support various file types including but not limited to Microsoft Windows Media Video files (.wmv), Microsoft Photo Story files (.asf), Microsoft Windows Media Audio files (.wma), MP3 audio files (.mp3), JPEG image files (.jpg, .jpeg, .jpe, .jfif), MPEG movie files (.mpeg, .mpg, .mpe, .m1v., .mp2v .mpeg2), Microsoft Recorded TV Show files (.dvr-ms), Microsoft Windows Video files (.avi) and Microsoft Windows Audio files (.wav).

The device 100 will also contain a display module 104 for displaying digital information such as video files, image files, text files, etc. This display may be in any current form in the art, including Liquid Crystal Displays (LCD), Light emitting diode displays (LED), Cathode Ray Tube Displays (CRT) or any other type of display currently existing or existing in the future. The display module 104 may also include an audio output device, e.g., a speaker 116, audio port 118, etc., allowing the user to also hear audio output from the device 100, e.g., audio associated with a video, a MP3 file, etc.

The device 100 of the present disclosure will contain a user input module 106 to either receive user instructions via text input by the way of buttons 108, a standard keyboard interface coupled to the device, or a character recognition capture device which translates user text input into alphanumeric characters. Preferably, the character recognition device is a touch screen which overlays the display module 104 and text is entered via a pen-like stylus. Such input devices are standard and currently available on many electronic devices including portable digital assistants (PDAs) and cellular telephones. Optionally, microphone 114 may be further coupled to the input module 106 for capturing any audio information spoken by the user and the input module will further include an analog-to-digital (A/D) converter for converting the spoken audio information into a digital format. Furthermore, the input module may include a voice recognition processor that translates the digital human voice into alpha numeric characters for user input. The user will utilize the user input module 106 to enter various data, for example, to enter payment information, to initiate communication with a remote server, to flag desired content to be downloaded, to request an initial selection of media content to be downloaded, etc.

The storage module 110 includes internal storage memory, e.g., random access memory (RAM), or removable memory such as magnetic storage memory; optical storage memory, e.g., the various known types of CD and DVD media; solid-state storage memory, e.g., a CompactFlash card, a Memory Stick, SmartMedia card, MultiMediaCard (MMC), SD (Secure Digital) memory; or any other memory storage that exists currently or will exist in the future.

The transmission module 112 will enable the device 100 to transmit or transfer information to other computing devices and to receive information from other computing devices, e.g., digital media files, codes to unlock downloaded media, encryption/decryption keys, etc. The transmission module 112 will perform its functionality by hardwired and/or wireless connectivity. The hardwire connection may include but is not limited to hard wire cabling e.g., parallel or serial cables, USB cable, Firewire (1394 connectivity) cables, and the appropriate port. The wireless connection will operate under any of the various known wireless protocols including but not limited to Bluetooth™ interconnectivity, infrared connectivity, radio transmission connectivity including computer digital signal broadcasting and reception commonly referred to as Wi-Fi or 802.11.X (where x denotes the type of transmission), satellite transmission or any other type of communication protocols or systems currently existing or to be developed for wirelessly transmitting data. The transmission module will compress and encode the encrypted information for transmission using any known wireless communication technology. In one embodiment, antenna ANT is coupled to the transmission module 112 for extending the wireless transmission range of the device 100.

A capture module 122 is provided to capture an image desired by the user in digital form, e.g., an image of an article of commerce, a barcode, etc. The capture module 122 includes an image sensor, an analog-to-digital (A/D) converter and a digital signal processor (DSP). Referring to FIG. 1B when a user desires to capture an image, a lens 137 disposed on a rear side of the device is aimed at a subject of the image and is used in conjunction with display module 104 for positioning a subject of the image in lieu of a viewfinder. Light is allowed to enter through the lens 137 and shine on the image sensor, e.g., a charge-coupled device (CCD) or complimentary metal-oxide semiconductor (CMOS). The image sensor includes preferably millions of photosensors, e.g., pixels, wherein each pixel absorbs the light and transforms the light into an electric charge proportional to the intensity of light. Each charge is transmitted to an A/D converter where the charge is converted into a digital value representing the color the pixel will be, e.g., representing different intensities of red, green and blue. The digital values are then passed to the digital signal processor which enhances the image, compresses it and then stores it in a digital file format in the storage module 110.

In other embodiments, the device 100 will further include an integrated scanning module 124 for scanning a symbology on an article of commerce. The scanning module 124 will contain a light source, e.g., LED, and photocell coupled to the computer processing module 120, or alternatively, will includes a separate decoder engine that will decode the data received by the photocell before sending it to the computer processing module 120. Knowledge of the art reveals that many different types of scanners currently exist and the inventor realizes that the type of scanner would depend upon the type of symbology that is utilized in the printed images. The symbology may be in any form currently practiced in the art including barcodes (e.g., UPC, EAN, PDF417, etc.), photosymbols, standard or specialized text, etc., or any future type of symbology.

It is to be appreciated that the capture module 122 may also be used in conjunction with the scanning module to read symbology associated with an article of commerce. Here, the capture module will acquire an image of the symbology and the scanning module will further include a digital signal processor executing an algorithm for deciphering or decoding the symbology from the capture image. The use of an image sensor to read symbology, e.g., a barcode, is known in the art and systems employing such technology is commercially available from Symbol Technologies of New York.

The device 100 will also include an encryption module 126. The encryption module 126 will use conventional code encryption algorithms currently in use or that will be in use in the future such as symmetric-key algorithms, e.g., DES, Triple-DES, Blowfish, RC2, RC4, RC5, etc, and asymmetric-key algorithms, e.g., Diffie-Hellman, RSA, ElGamal, etc. to decrypt locked digital media content files that are stored in the storage module 110. The encryption module 126 may also encrypt payment information of a user before the payment information is transmitted to another device or server.

Furthermore, the device 100 will include a date and time module 128. The date and time module 128 will use standard computer chip processing technology widely in use, e.g., a crystal, or alternatively, input from a GPS receiver to supply the date and time.

In one embodiment, the device 100 according to the principles of the present disclosure is embodied as a mobile phone including the modules and architecture illustrated in FIG. 2. In this embodiment, microphone 106 is further coupled to a communication module 130 for encoding a user's speech to be transmitted via antenna ANT using CDMA, PCS, GSM or any other known wireless communication technology. The user will enter phone numbers to be dialed via the touch screen, or alternatively, as is known in the mobile phone art, the device 100 may include a full QWERTY keyboard as an input module to enter text information. In addition to producing audio from audio or multimedia content, speaker 116 will be coupled to the antenna ANT and a decoder for receiving and decoding voice communication from another mobile phone.

It is to be appreciated that the communication module 130 may include a single integrated circuit chip to perform data transfer and voice communications or a single module including a separate data transfer chip, e.g., a WiFi transceiver, and a separate voice communication chip, e.g., a CDMA chip. In one embodiment, the communication module will operate on the wireless GPRS (General Packet Radio Service) data protocol or a 3G protocol such as W-CDMA, CDMA2000 and TD-SCDMA. Both the GPRS and 3G protocols have the ability to carry both voice and data over the same service.

It is to be appreciated that the device 100 described above is an exemplary device and may include all or a portion of the modules described above. Furthermore, it is to be appreciated that existing mobile devices, e.g., mobile phones, digital media playback device, may be used in accordance with the principles of the system and method of the present disclosure described below.

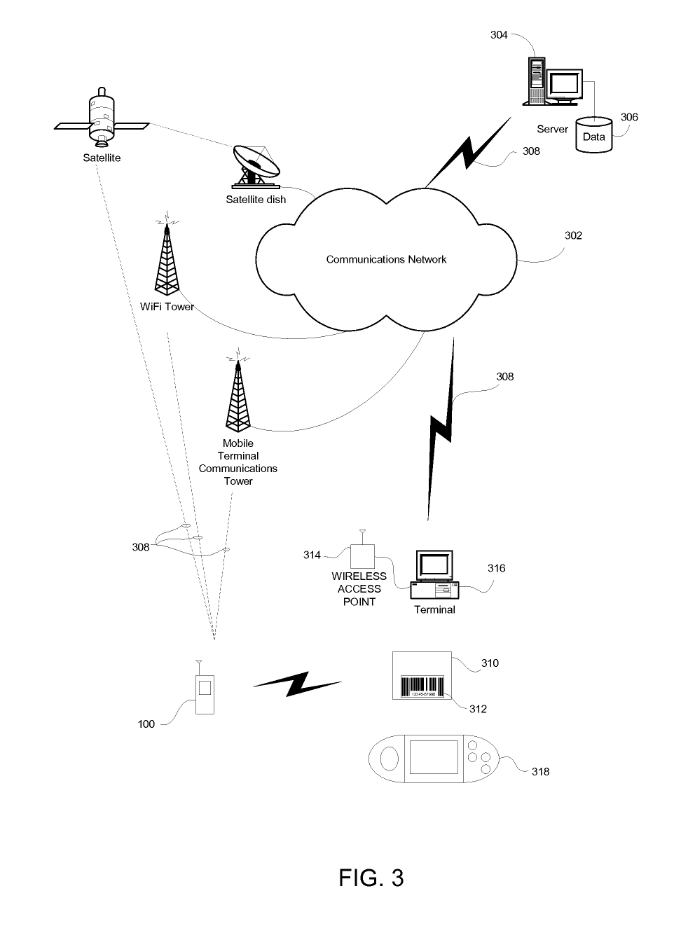

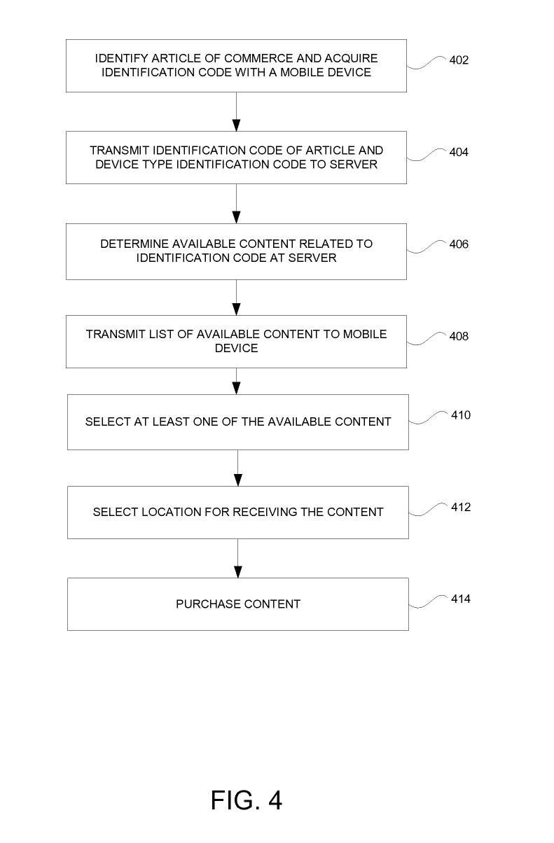

A system and method for identifying an article of commerce and delivering media content related to the article to a user over a network will be described in relation to FIGS. 3 and 4. Referring to FIG. 3, a system in accordance with the present disclosure is illustrated. The system includes a mobile device 100 as described above. The device 100 will communicate to a server 304 via a communication network 302. The device 100 and server 304 may be connected to the communications network 302, e.g., the Internet, by any known means, for example, a hardwired or wireless connection 308, such as dial-up, hardwired, cable, DSL, satellite, cellular, PCS, wireless transmission (e.g., 802.11a/b/g), etc. It is to be appreciated that the network 302 may be a local area network (LAN), wide area network (WAN), the Internet or any known network that couples a plurality of computers to enable various modes of communication via network messages. Furthermore, the server 304 will communicate using the various known protocols such as Transmission Control Protocol/Internet Protocol (TCP/IP), File Transfer Protocol (FTP), Hypertext Transfer Protocol (HTTP), etc. and secure protocols such as Internet Protocol Security Protocol (IPSec), Point-to-Point Tunneling Protocol (PPTP), Secure Sockets Layer (SSL) Protocol, etc. The server 304 will further include a storage medium 306 for storing a database which links articles of commerce to various type of digital content, the details of which will be described in detail below.

Initially, in step 402, a user will identify an article of commerce and acquire an identification code from the article using a mobile device 100. The article of commerce could take many forms including but not limited to a book, a video or audio DVD, an audio CD, an electronic game, etc. As will be appreciated from the description below the identification code may take many forms such as a barcode number, a UPC number, a alphanumeric number assigned to the article of commerce, a name of the article, e.g., Batman Begins DVD, etc. The present disclosure may use any one or any combination of identification codes to determine if related content if available, for example, if a user identifies the article by name, the name will be used in a search engine to determine an associated alphanumeric code which will then be used to locate a record to determine if any related content is available for the identified article.

The user will utilize the portable digital device 100 to identify the article of commerce. For example, if the article of commerce 310 includes a barcode 312, the device 100 will scan the barcode 312 with the scanning module 124 and decode the barcode to acquire an identification code of the article. Alternatively, the device 100 will capture an image of the barcode using the capture module 122 and decode the barcode to acquire an identification code of the article. Furthermore, the user can also take a picture of the article of commerce via the capture module 122. Then using standard and existing computer processing power and software solutions such as Attrasoft Image recognition software, or optical character recognition software (OCR software such as OmniPage or Read Iris) the image or name of the article of commerce is decoded and the identity of the article of commerce is resolved.

In another embodiment, the user will enter the identification code of the article via a user interface including input module 106. If the device contains a user interface allowing user keyboard input, the user will input the name of the article into the portable device. The user may also speak the name of the article of commerce into the portable device via the microphone 114 which in turn will process the spoken name into digital form via speech recognition software.

In a further embodiment, the articles of commerce will contain Radio Frequency Identification (RFID) tags. The portable digital device 100 will contain an RFID reader and the identity of the article of commerce will be resolved.

In another embodiment, the name or identification code of at least one article of commerce will be broadcast via a WiFi wireless access point 314 over a predetermined range. The device will receive this transmission via transmission module 112 and will present a listing of content to the user via the display module 104. The user may then select an article of interest. An example of this embodiment would be in a retail store, e.g., a movie rental store, where a list of new movie releases is continuously broadcast in the store via a wireless access point coupled to a server or terminal 316 in the store. This list would only be available when within the confines of the store. The device would present this list to the user and the user may select a movie of interest wherein the identification code for the movie, i.e., the article of commerce, would be identified via the terminal 316.

Furthermore, the name or identification code of an article of commerce may be broadcast from another mobile device, e.g., a gaming device 318. Here, a user approaches a second user having a gaming device 318 having at least one electronic game either stored in memory or currently being played. The gaming device 318 will broadcast the identification code of the at least one game, or alternatively, the second user may initiate the identification code being transferred, e.g., via an infrared port, to the first user.

Once the article of commerce is identified, the portable device 100 will use communications protocols including but not limited to WiFi (a, b, c d, n, x), mobile phone communications such as GSM, CDMA, FOMA, etc., infrared communications, cabled communications, Bluetooth communications, satellite communications, to transmit the identification code to a remote server on the global computer network (GCN), e.g., the Internet (step 404). It is to be appreciated the device 100 may use any one or a combination protocols to transmit the identification code to the server 304. For example, the device 100 may employ a telecommunication protocol to transmit the identification code via the communication module 140. In another embodiment, the device 100 may communicate to the server 304 via the same wireless access point 314 that broadcast the list of available content, e.g., a hot spot in a retail location.

In step 404, the device 100 will also transmit information identifying the user submitting the request. Furthermore, the device 100 will transmit a device type identification code to the server so the server may determine available content compatible with the device, e.g., ring tones for a mobile phone.

The server 304 may be maintained by a vendor associated with the article of commerce. For example, in the case of identifying a Warner Brothers™ DVD movie, the server may be a Warner Brothers server connected to a Warner Brothers website. However, the server may also be a vendor not associated or even competing with the article of commerce. For example, if the article of commerce is a Warner Brothers™ DVD movie, the server may be an e-commerce site such as Amazon.com that offers DVD movies from many companies including Warmer Brothers.

In step 406, the server 304 will then use standard computer processing power and standard database look up software (e.g., Microsoft™ Access or Oracles™ Database software) to see if it has information on the article of commerce in its database 306. Such information will include but not be limited to what the article of contains (including chapters, episodes, songs, ring tones, etc.), and whether full or partial digital content is available for download for the identified article of commerce and, if available, the location of the content. In one embodiment, the server will select available content based on the device type identification code. For example, if the device type identification code indicates a mobile phone, the server will determine if ring tones are available. If the device type identification code indicates a mp3 player, the server will determine if audio content is available. Further, the server will also identify the user requesting the information on the article of commerce and what the user's preferences and device locations are for downloading the selected content, as well as any existing e-commerce information on the requested user such as stored credit card and address information.

The server 304 will then use standard communications protocols described above to transmit or download the determined information, e.g., a list of available content, back to the portable digital device (step 408). This information will appear on the display of the portable digital device, although in another embodiment, this information may also be given to the user by audio via speaker 116 by utilizing a text-to-speech software program. The user will now be informed, i.e., by the server, what content or parts of content for the selected article of commerce is available for download e.g., either to purchase or preview. The user will also be informed of the price of this download. Optionally, the user will be informed where the download will be sent to using the information the user has previously supplied the server, e.g., a home computer of the user which is coupled to the network 302.

If the user wants to purchase any of the available content, the user will now use the user interface of the portable digital device including but not limited to character input, or voice input to enter his selection and make the purchase (step 410). Optionally, the user may also select a location for receiving the content other than the mobile device 100, e.g., a computer, a second mobile device, etc. (step 412). This information, e.g., location information, credit card information, etc., will be inputted into the portable digital device via the user interface and will then be transmitted to the server. The server will use standard computer processing power and e-commerce software to approve the transaction (step 414). Once (and if) the transaction is approved, the server will transmit the digital content to the address that the user has provided, e.g., the mobile device, a mobile phone, a local personal computer, etc. . . . In another embodiment, the server 304 may not have stored the digital content, but it may cause another site or server on the global computer network where the subject digital content is stored, to transmit the content to the user at the address provided.

In another embodiment, the user will select the desired content and download the content to preview the content before conducting a purchase transaction. The preview of the content may be a portion of the content that will be downloaded to the device specified by the user. After previewing the device, the user may purchase the complete content via a standard e-commerce transaction. Alternatively, the complete content will be transmitted to the user for preview. In this embodiment, the content may be enable for a predetermined period time so the user can preview the content where when the predetermined period of time expires, the user will either purchase the content or the content will be disabled. Alternatively, a portion of the complete content may be enabled to be view by a user where the user will purchase a key for example to enable the complete content selection.

Once the content is transmitted to the portable digital device (or in some cases to the user's home computer), the content will be stored in the memory of the device. The user may call this content from memory at any time and using standard computer processing power and software application programs such as Apple's™ iTunes, Microsoft's™ Media Player, text reader programs, music ring tone playback programs, etc., the content can be utilized.

In another embodiment of the present disclosure, the user may use one device to identify the article of commerce, and to transmit the identification code of the article to the remote server. This same device will also be used to implement the e-commerce transaction that allows the user to purchase the selected content. However, in this embodiment the server, or affiliated servers, will transmit the selected content to a second device, e.g., another portable digital device for use by the user, a home personal computer, a personal computer of a friend, etc.

In another embodiment, after the user has selected at least one of the available content (step 410), the selection will be transmitted to the server and the server will retrieve a purchase price or transaction amount from a plurality of different vendors or distributors of the at least one content. The information from the plurality of vendors will be complied into a list to be transferred to the device. At the device, the list will be presented to the user so the user may conduct comparison shopping of the at least one available content at a point of purchase, e.g., a retail location.

In utilizing the principles of the present disclosure, a user will be able to accomplish the various applications described below where content is identified and delivered to a device:

Music Content to Ring tones

Conventional mobile telephones allow a user to select custom ring tones to allow the user to hear a ring tone of their choice. The user must scroll through a selection choice provided by the service carrier and then downloads the digital ring tone files to their telephone. The selection choice is limited and cumbersome to the user, in that, the user has to scroll through many menus to finally select his/her hopeful choice.

With the present disclosure, the user would be able to walk into any retail establishment, or in fact into any location (including a friends home, etc), that has digital content. The user would then have the mobile phone identify the selected media content (e.g., a music CD), transmit the identification code of the content to a remote server and the server would tell the user if any ring tones are available for the selected content. If ring tones are available, the user could purchase the selected ring tone or ring tones, and the user would then download this tone into his mobile phone. This whole transaction could take place in several minutes time as opposed to the current system of endlessly looking through menus and submenus for the ring tone that the supplier offers.

### Games to Portable Game Player Devices

Using the system and method described herein the user would be able to walk into any retail establishment or, in fact, into any location (including a friends home etc) that has digital content, e.g., a game. The user would then use the user interface on the applicable digital device such as the Sony™ PSP to identify the selected media content, e.g., enter a name of the game, pickup the identification code wirelessly via its WiFi capability via a broadcast access point or directly from another gaming device, etc. The device will then transmit the identification code of the content to a remote server and the server would inform the user if the game content of the selected game is available for the selected content. If the content is available, the user could purchase the selected game, and the user would then download this game into his digital device. This whole transaction could take place in several minutes time. If the selected article of commerce contained multiple games, the user could select just one or more of the games as opposed to the whole content.

In another embodiment of the present disclosure, the user could use one portable digital device, such as a mobile phone (perhaps with an integrated CCD device) to identify the article of commerce, use this same device to purchase the selected digital content, and then direct the digital content to be downloaded on another portable media device, e.g., a gaming device, or even to have the content downloaded on the user's desktop computer.

### Text to Portable Digital Text Reader

Using the system and method described herein, the user would be able to walk into any location that has digital content in this case text content (such as a book or a magazine.) The user would then use the user interface on the applicable digital device such as the HP Windows CE Ipaq H6325 (which includes an integrated camera and a cellular phone) to identify the selected media content, transmit the identification code of the content to a remote server and the server will inform the user if content of the book or magazine is available. If the content is available, the user could purchase the selected content, and the user would then download this content into this digital device. This whole transaction could take place in several minutes time. If the selected article of commerce contained articles, chapters, etc. of the selected printed material, the user could select just one or more of the articles, chapters, etc. as opposed to the whole content.

In another embodiment of the present disclosure, the user could use one portable digital device, such as a mobile phone (perhaps with an integrated CCD device) to identify the article of commerce, and then use this same device to purchase the selected digital content, and then direct the digital content to be downloaded on another portable media device, or even to have the content downloaded on the user's desktop computer. Of course, once the content is downloaded the user can utilize the content by employing any number of text reader applications specific to the digital device that the user has downloaded the content to.

### Audio or Video Content to Portable Digital Player

Using the system and method described herein, the user would be able to walk into any retail location (or any other location) that has digital audio or video content such as a music DVD, music CD, audio book or a DVD of a film or television show, etc. The user would then use the user interface on the applicable digital device such as the Archos PMA430 from Archos of Irvine, Calif. (which includes integrated WiFi) to identify the selected media content e.g., enter a name of the content, pickup the identification code wirelessly via its WiFi capability via a broadcast access point or directly from another media playing device, etc. The device will then transmit the identification code of the content to a remote server, and the server would inform the user if the content of the music or film DVD is available. If the content is available, the user could purchase the selected content, and the user would then download this content into this digital device. This whole transaction could take place in several minutes time. If the selected article of commerce contained multiple songs as is the case with a music CD/DVD or episodes as is the case with many television/movies DVDs, the user could select just one or more of these songs or episodes as opposed to the entire content.

In another embodiment of this invention, the user could use one portable digital device, such as a mobile phone (perhaps with an integrated CCD device) to identify the article of commerce, and then use this same device to purchase the selected digital content, and then direct the digital content to be downloaded on another portable media device, or even to have the content downloaded on the user's desktop computer. Of course, once the content is downloaded the user can play the content by using any number of media player software applications such as iTunes from Apple Computers, Inc. of Cupertino, Calif. or Microsoft Media Player from Microsoft of Redmond, Wash. .

The system and method of the present disclosure will provide a user with not only instant delivery, but a seamless way of obtaining content (as opposed to manually loading the content), and in many cases, a better economic model to obtain the content. The latter statement is supported because the present disclosure allows the user to compare the price of the content at the source (for example, a retail store) versus the price to instantly receive the content from an Internet source or sources. Further, the user may custom select the content that he desires and, instead of obtaining all content, he may decide to purchase less of the content (i.e., a portion or subset of the content) therefore customizing his selection, and reducing his/her price for the content.

While the disclosure has been shown and described with reference to certain preferred embodiments thereof, it will be understood by those skilled in the art that various changes in form and detail may be made therein without departing from the spirit and scope of the disclosure as defined by the appended claims.

What is claimed is:

1. A method for delivering media content to a mobile device over a network, the method comprising the steps;
identifying a specific article of commerce;
acquiring an image of the article by using a mobile device;
transmitting the acquired image of the article of commerce from the mobile device to a server on the network;
determining, by the server, at least one available content related to the article of commerce based on the acquired image of the article of commerce; and
transmitting the at least one available content from the sever to the mobile device.

2. The method as in claim 1, further comprising purchasing the selected at least one available content via a user interface of the mobile device.

3. The method as in claim 1, wherein the at least one available content is a ring tone, a game, video content, audio content, multimedia content, text or a software application.

4. The method as in claim 1, further comprising presenting on a user interface of the mobile device a list of purchase prices from a plurality of vendors for the at least one available content.

5. The method as in claim 1, further comprising transmitting a device type identification code to the server and determining the at least one available content related to the article of commerce based on the acquired image of the article of commerce and the device type identification code.

6. The method as in claim 5, wherein the device type identification code indicates a mobile phone and the at least one available content is a ring tone, a game, video content, audio content, multimedia content, text or a software application.

7. The method as in claim 5, wherein the device type identification code indicates a portable media player device and the at least one available content is a game, video content, audio content, multimedia content, text or a software application.

8. The method as in claim 1, wherein the acquired image includes a barcode of the article of commerce.

9. The method as in claim 1, wherein the article of commerce is printed matter and the at least one available content is text.

10. A system for delivering media content to a mobile device over a network, the system comprising:
a mobile device for playing content configured to acquire an image of a specific article of commerce and to transmit the acquired image of the article of commerce to a server; and
the server configured for receiving the acquired image, determining at least one available content related to the article of commerce based on the acquired image, and transmitting the at least one available content to the mobile device.

11. The system as in claim 10, wherein the mobile device is further configured to purchase the selected at least one available content via a user interface disposed on the mobile device.

12. The system as in claim 10, wherein the acquired image includes a barcode of the article of commerce.

13. The system as in claim 10, wherein the at least one available content is a ring tone, a game, video content, audio content, multimedia content, text or a software application.

14. The system as in claim 10, wherein the mobile device is configured for transmitting a device type identification code to the server and the server is configured for determining the at least one available content related to the article of commerce based on the acquired image of the article of commerce and the device type identification code.

15. The system as in claim 10, wherein the article of commerce is printed matter and the at least one available content is text.

16. A mobile device comprising:
an image capture device configured to capture an image of an article of commerce;
image recognition software disposed in a memory, the image recognition software configured, when executed by a processing module, to decode the captured image of the article of commerce to determine the identity of the article of commerce;
a transmission module configured to transmit the identity of the article of commerce to a server, the transmission module further configured to receive from the server and store in the memory at least one available content related to the article of commerce; and
a display module configured to display the at least one available content.

17. The mobile device as in claim 16, further comprising an input module configured to receive a purchase input from the user, the purchase input indicating an intention to purchase the selected content.

18. The mobile device as in claim 16, wherein the additional content includes at least one of a ring tone, a game, video content, audio content, multimedia content, text or a software application.

19. The mobile device as in claim 16, wherein the acquired image includes a barcode of the article of commerce.

20. The mobile device as in claim 16, wherein the article of commerce is printed matter and the at least one available content is multimedia content.

21. A system for delivering content to a mobile device over a network, the system comprising:
a mobile device including:
an image capture module configured to capture an image of an article of commerce; and
a transmission module configured to transmit the captured image to a server on the network; and
the server including image recognition software, the image recognition software configured, when executed by a processing module, to decode the captured image of the article of commerce to determine the identity of the article of commerce, the server further configured to determine at least one available content related to the article of commerce based on the determined identity of the article of commerce and transmit the at least one available content to the mobile device,
wherein the transmission module of the mobile device is further configured to receive from the server and store in a memory the at least one available content related to the article of commerce and
the mobile device including a display module configured to display the at least one available content.
